(19) United States
(12) Patent Application Publication
(10) Pub. No.: US 2008/0305324 A1
(43) Pub. Date: Dec. 11, 2008

(54) Multilayer Optical Disc Construction and Fabrication

(76) Inventors: Kirill Donetzkiy, Moscow (RU); Galina Dorozhkina, Dolgoprodnij (RU); Alexey Lezhnev, Moscow (RU)

Correspondence Address: WINSTON & STRAWN LLP;PATENT DEPARTMENT, 1700 K STREET, N.W., WASHINGTON, DC, 20006, US

(21) Appl. No.: 12/065,476

(22) PCT Filed: Sep. 12, 2006
(86) PCT No.: PCT/US06/35547

§ 371 Date: Feb. 29, 2008

Related U.S. Application Data
(60) Provisional application No. 60/716,778, filed on Sep. 12, 2005.

(51) Int. Cl. B32B 17/10; B32B 27/38; B32B 27/00; B32B 37/00

(52) U.S. Cl. 428/339; 428/413; 428/500; 428/480; 156/313

(57) ABSTRACT

The present invention is directed to multilayer optical discs that include a plurality of information layers, and at least two different, adjacent separating layers located in a space between at least two of the information layers. Each of the at least two separating layers includes a different polymer that imparts different properties to the disc. Methods of making the discs, and methods of preparing an optical information storage medium, are also included.

### FIELD OF THE INVENTION

The invention relates to improved multilayer optical discs and methods of making such discs.

### BACKGROUND OF THE INVENTION

U.S. Pat. No. 6,039,898 discloses a conventional procedure for the construction and fabrication of a multilayer optical disc. Referring to prior art FIG. 1, the disc includes an informational contour (i.e., a relief) 1, which is filled with a fluorescent dye and with a separating layer 2 between each pair of information layers.

In some cases where it is necessary to provide for special properties of an information layer, such as, for example, increased timebase, photostability, or thermostability, or to eliminate the possibility of the dye diffusing together with the solvent into the material of the informational contour-forming layer, one must use a contour-forming layer that has either a very high degree of resistance to that solvent, or a very high degree of density and hardness—properties inherent to the mesh of a solidified material.

As a result, it is conventional to use photopolymeric compositions (e.g., as disclosed in U.S. Pat. No. 6,500,602 and U.S. Publication No. 2001/0048977) that have, after photopolymerization, a very high density of the solidified-material mesh and a high hardness. Such compositions, however, typically result in high shrinkage (8-12%), and this results in a disc that exhibits tangential and radial heaving, bending or warpage. This is especially true when multilayer discs are concerned, since the mechanical strain in any such disc will be the summation of several strains at a time—strains from the multiple layers of the disc.

Therefore, a need exists to provide a multilayer disc that does not exhibit this level of heaving, bending, or warpage.

### SUMMARY OF THE INVENTION

The present invention relates to a multilayer optical disc that includes a plurality of information layers, and a separating layer arrangement that includes at least two adjacent separating layers. The a separating layer arrangement is located between two information layers and has a thickness sufficient to maintain the at least two information layers spaced apart from each other to minimize strain in the disc. First and second separating layers of the separating layer arrangement are of different polymer materials to impart different properties to the disc.

In one embodiment, the separating layer arrangement has 2 to 6 separating layers. In another embodiment, the disc has 2 to 10 information layers, each of which is separated by a separating layer arrangement. The properties typically include one or more of: solvent resistance, electrical conductivity, thermal conductivity, refraction value, or a mechanical property.

Preferably, the polymer material includes one or more photopolymers. Suitable photopolymers include, for example, bis(4-glycidyloxyphenyl)methane; 1,2,7,8-diepoxyoctane; bisphenol A diglycidyl ether; 1,4-cyclohexanedimethanol diglycidyl ether; 1,4-butanediol diglycidyl ether; bis(3,4-epoxycyclohexylmethyl) adipate; diglycidyl-1,2-cyclohexanedicarboxylate; 3-[bis(glycidyloxymethyl)methoxy]-1,2-propanediol; poly(bisphenol a-coepichlorohydrin), glycidyl end-capped; 3,4-epoxycyclohexylmethyl-3,4-epoxycyclohexane-carboxylate; 3-diglycidyl-1,2-cyclohexanedicarboxylate; poly[(o-cresyl glycidyl ether)-co-formaldehyde]; glycerol proxylate triglycidyl ether; poly(vinylbutyral-co-vinylalcohol-co-vinyl acetate; poly(caprolactone) triol; glycidyl methacrylate; 4-vinyl-1-cyclohexane diepoxide; poly(propylene glycol) diglycidyl ether; glycidyl methacrylate; ethylene glycol divinyl ether; di(ethylene glycol)divinyl ether; trimethylpropane trivinyl ether; 1,6-hexanediol diacrylate; ethoxylated o bisphenol A diacrylate; epoxy novolac acrylate oligomer in HDDA; polyester acrylate; styrene; modified urethane triacrylate; 2-(2-ethoxyethoxy)ethyl-acrylate; monopropyleneglycol acrylate; propoxylated trimethylopropane triacrylate; oligocarbonate methacrylate; aliphatic urethane (di)triacrylate; aromatic urethane (di)triacrylate; pentaerythritol triacrylate; tripropylene glycol triacrylate; 4-vinyl-1-cyclohexane 1,2-epoxide; tripropyleneglycol divinyl ester; trimethylpropane triacrylate; oligocarbonate methacrylate; diepoxide propyleneglycol; bisphenol A epoxy acrylate; propoxylated neopentyl glycol diacrylate; neopentyl glycol diacrylate; neopentyl glycol ethoxylate diacrylate; hexanediol diacrylate (HDDA); hydroxyethyl(meth)acrylate; tripropyleneglycole diacrylate; epoxy (meth)acrylates; aliphatic urethane (di)triacrylate; aromatic urethane (di)triacrylate; polypropyleneglycol diacrylate (900); 2-phenoxyethyl acrylate; isobornyl acrylate, tris (2-hydroxy ethyl)isocianurate triacrylate, or a mixture thereof.

In an exemplary embodiment, a first polymer material includes: propoxylated trimethylopropane triacrylate; oligocarbonate (meth)acrylate; hexanediol diacrylate (HDDA); polyester acrylate; styrene; tripropylene glycol triacrylate; trimethylpropane triacrylate; neopentylglycol diacrylate; hydroxyethyl(meth)acrylate; tripropyleneglycole diacrylate; epoxy (meth)acrylates, or a mixture thereof, and a second polymer material includes ethoxylated bisphenol A diacrylate; aliphatic urethane (di)triacrylate; aromatic urethane (di)triacrylate; propoxylated trimethylopropane triacrylate; polypropyleneglycol diacrylate (900); epoxy (meth)acrylates; 2-phenoxyethyl acrylate; isobornyl acrylate; tris (2-hydroxy ethyl)isocianurate triacrylate, or a mixture thereof.

Each of the separating layers generally has a thickness of about 10-65 μm. The information layer usually includes a plurality of depressions at a surface of each of the at least two separating layers.

The present invention further relates to a method of making the disc. The method includes separately preparing each of the different first and second separating layers, combining the two layers to form a separating layer arrangement, and locating the separating layer arrangement between two information layers. In a preferred embodiment, combining the two layers includes disposing a light-reactive adhesive composition between the first and second layers, and photosolidifying the adhesive composition thereto.

In addition, the present invention relates to a method of preparing an optical information storage medium. The method includes providing a plurality of pits to a first surface of a first separating layer and to a first surface of a second separating layer, wherein the pits correspond to reproducibly detectable information, and combining the first and second separating layers by joining a second surface of each separating layer that is disposed opposite the first surface of each separating layer to form a structure having the pits on at least two outer surfaces thereof.

In one embodiment, the second surface of the first and second separating layers is permanently joined by an adhesive composition disposed therebetween.

The present invention also relates to another method of preparing an optical information storage medium. The method includes disposing a first polymerizable composition between a base and a covering layer, with at least one of the base and the covering layer having a first relief pattern on a side facing the first polymerizable composition; rotating the base, the first polymerizable composition, and the covering layer to more uniformly distribute the first polymerizable composition therebetween; polymerizing the first polymerizable composition while the first polymerizable composition is distributed between the base and the covering layer so as to form a first polymerized layer having a second relief pattern corresponding to the first relief pattern; filling the second relief pattern with a recording medium; disposing a second, different polymerizable composition between a side of the first polymerized layer opposite the second relief pattern and a covering layer having a third relief pattern facing the second polymerizable composition; spinning the base, first polymerized layer, the second polymerizable composition, and the covering layer to more uniformly distribute the second polymerizable composition therebetween; polymerizing the second polymerizable composition to form a second polymerized layer having a fourth relief pattern corresponding to the third relief pattern; and filling the fourth relief pattern with a recording medium.

In a preferred embodiment, the method includes adding one or more photoinitiators to the first or second polymerizable composition before polymerizing the composition. Suitable photoinitiators include, for example, 2-hydroxy-2-methyl-1-phenyl-1-propanone (commercially available as Irgacure® 1173 and Darocur® 1173 from Ciba-Geigy); benzoin isobutyl ether; bis(η5-2,4-cyclopentadien-1-yl)-bis(2-6-difluoro-3-(1H-pyr-rol-1-yl)-phenyl)titanium (commercially available as Irgacure® 784 from Ciba-Geigy); 2,2-dimethoxy-2-phenyl acetophenone (commercially available as Irgacure® 651 from Ciba Geigy); phenanthrenequinone; triethanolamine; camphorquinone; eosin B; dibutylaniline; a 25:75 mixture, by weight, of bis(2,6-dimethoxybenzoyl)-2,4,4-trimethylpentyl phosphine oxide and 2-hydroxy-2-methyl-1-phenylpropan-1-one (commercially available as Irgacure® (1700 from Ceiba-Geigy); a mixture of 1-hydroxycyclohexyl phenyl ketone and benzophenone (commercially available as Irgacure® 500 from Ciba-Geigy); mixed triarylsulfonium hexafluoroantimonate salts (commercially available as Cyracure® UVI 6974 from The Dow Chemical Company); triarylsulfonium hexafluoroantimonate; triarylsulfonium hexafluorophosphate; acyl phospho oxides, such as Irgacure® 149 from Ciba-Geigy; (η⁵-2,4-cyclopentadien-1-yl)[(1,2,3,4,5,6-η)-(1-methyl ethyl)benzene]-iron (+)-hexafluorophosphate (−1) (commercially available as Irgacure®261 from Ciba-Geigy), or a mixture thereof.

The recording medium typically includes one or more of a fluorescent material, photochromic material, scattering material, reflective material, or a combination thereof. In one embodiment, the first polymerized layer is separated from the base before filling the second relief pattern with the recording medium, and in another embodiment, filling the fourth relief pattern with the recording medium is done before filling the second relief pattern.

In yet another embodiment, the first or second polymerizable composition is photopolymerizable, and the covering layers are at least substantially transparent. Preferably, the method further includes applying a metal mask to a portion of the base during polymerization to avoid polymerizing the polymerizable composition covering such portion. The method may also include washing the first or second polymerized composition, or both, with a solvent to remove an unpolymerized portion thereof. Advantageously, the first relief pattern may include a plurality of projections to increase wettability of the relief pattern to the first polymerizable composition so that the projections form a corresponding pattern thereon.

### BRIEF DESCRIPTION OF THE DRAWINGS

Further features and advantages of the invention can be ascertained from the detailed description that is provided below in connection with the following drawing(s):

FIG. 1 is a multilayer optical disc with a single separating layer between information layers according to the prior art;

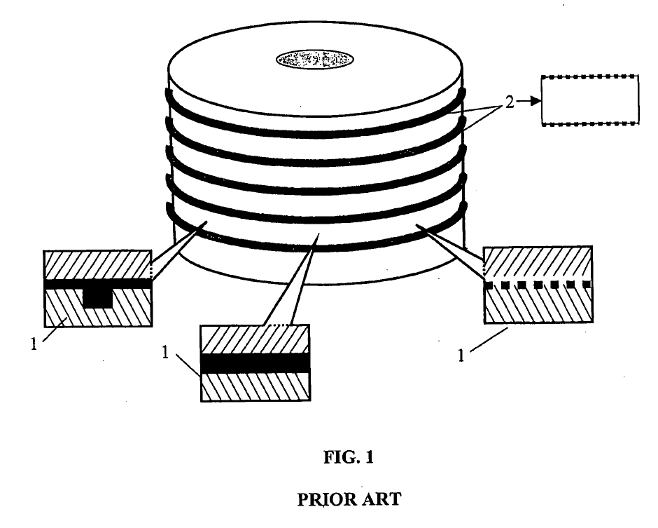

FIG. 2 is a multilayer optical disc according to a preferred embodiment of the present invention; and

FIG. 3 is a stamper organization that may be used to prepare an optical information storage medium according to the present invention.

### DETAILED DESCRIPTION OF THE PREFERRED EMBODIMENTS

To solve the above-mentioned problems, it has now been discovered that a separating layer arrangement to minimize or avoid disc strain can be achieved according to the present invention. This arrangement can advantageously be provided by combining two or more different polymeric layers in the spacing arrangement between a pair of information layers, such that each separating layer can impart distinct physical properties, chemical properties, or both, to the information layer or disc as a whole. Preferably, the arrangement includes from 2 to 6 separating layers, more preferably from 2 to 4 separating layers, and in a most preferable embodiment, from 2 to 3 separating layers. In an exemplary embodiment, the 2 separating layers are provided between a pair of information layers.

An exemplary separating layer arrangement can include a first separating layer that can provide solvent resistance to protect the information layer during filling of the pits or grooves, while optionally but preferably also providing one or more enhanced mechanical properties, such as elongation to break, tensile strength, or notched impact after curing to the information layer. The second separating layer can act as a current conductive layer or have a different refraction value, while an optional another layer may be included to provide for additional enhancement of one or more mechanical properties, such as tensile elongation at yield, elongation to break, or flexural modulus after curing of the entire disc.

The number of layers in the disc is limited solely by the permissible thickness of the whole optical disc, which is typically about 1 mm to 2 mm. Each layer is typically about 5 μm to 100 μm, preferably about 10 μm to 70 μm, and more preferably about 15 μm to 50 μm. The layers in the disc are preferably at least substantially planar, at least substantially parallel to each other, and more preferably both. In a preferred embodiment, a plurality of the layers in the disc are planar and parallel to each other.

In one embodiment, the disc can include more than two information layers, such as from 3 to 10 information layers. Although the separating layer arrangement of at least two layers is disposed between at least two of the information layers, preferably there is a separating layer arrangement between each of the information layers in the disc.

The layers of the disc are typically formed of a polymerizable material, preferably a photopolymerizable material that is polymerized predominantly or even entirely by cation and/or radical mechanisms, and low- and/or high-molecular weight components, which are preferably in liquid form. The polymerizable material can include one or more functional groups that permit photopolymerization by both cation and radical mechanisms, with groups of different chemical nature being incorporated in the same or different materials. The polymerizable material may also be polymerized by a hybrid mechanism.

For cation-mechanism-polymerizable components, preferably cyclic esters, formals, acetals, lactones, mono and polyfunctional epoxides, epoxyoligomers, oxethanes, and vinyl monomers, including fluorinated and organosilicon compounds, or any combination thereof, may be used, with one or more epoxy materials being preferred. For radical-mechanism-polymerizable components, substances containing unsaturated double bonds, predominantly of (metha)acrylic type including fluorinated ones, are preferred. For components polymerizable by hybrid mechanism, it is preferable to use glycidyl ethers with unsaturated double bonds. The polymerizable substance may comprise mono- or polyfunctional comonomers, preferably those that increase the polymerizable material sensitivity to the action of actinic radiation, or those comonomers that impart beneficial physical or mechanical characteristics to the photosolidified information layer. Preferred physical and/or mechanical properties include optical, spectral, luminescent, and adhesive. In an exemplary embodiment, a polymerizable layer is made of a material such as V lacquer 1322 000 40039, which is commercially available from Phillips Coating B.V., Holland, or UV adhesive Kayarad DVD-003, which is commercially available from Nippon Kayaku Co. Ltd.

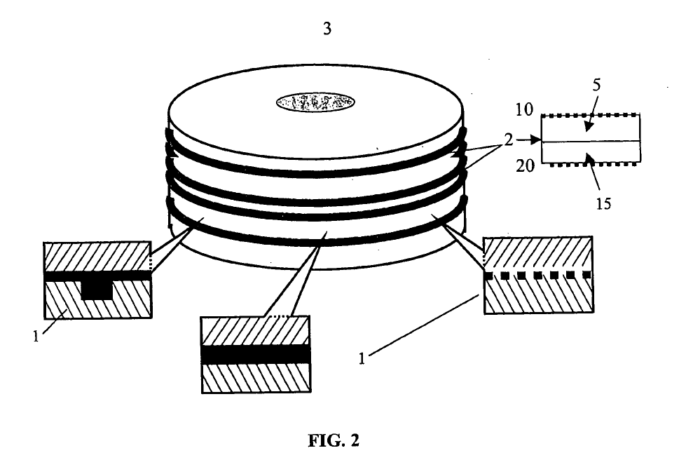

An example of a multilayer disc 3 where the space 2 between at least two information layers 10, 20 is made up of at least two separating layers 5, 15 is discussed below. The information layers generally include different informational contours 1. Referring to FIG. 2, the first separating layer 5 includes one polymer material, e.g., including photopolymer I, which includes a thin informational contour (or relief) 10 on one surface and has all the specific properties required. For example, the first layer 5 exhibits the firmness and density inherent in the mesh of a solidified material. Suitable polymers for inclusion in the first layer 5 include: propoxylated trimethylopropane triacrylate; oligocarbonate (meth)acrylate; hexanediol diacrylate (HDDA); polyester acrylate; styrene; tripropylene glycol triacrylate; trimethylpropane triacrylate; neopentylglycol diacrylate; hydroxyethyl(meth)acrylate; tripropyleneglycol diacrylate; epoxy (meth)acrylates, or a mixture thereof. The first layer 5 can typically be from about 5-15 μm thick.

The second separating layer 15 includes another polymer material, e.g., including photopolymer II, that has high-elasticity, high spring-power and low shrinkage. Suitable polymers for inclusion in the second layer 15 include ethoxylated bisphenol A diacrylate; aliphatic urethane (di)triacrylate; aromatic urethane (di)triacrylate; propoxylated trimethylopropane triacrylate; polypropyleneglycol diacrylate (900); epoxy (meth)acrylates; 2-phenoxyethyl acrylate; isobornyl acrylate; tris (2-hydroxy ethyl)isocianurate triacrylate; or a mixture thereof. Thus, the second layer 15 will serve to reduce or even negate the mechanical strains generated in the first layer 5 and, as a result, decrease the tangential and radial bending or warpage of the disc 3. In addition, such a buffer layer 15 will mitigate the synergistic effect of the mechanical strains from the various layers. The second layer 15 can typically be from about 10-50 μm thick. It should be understood that any suitable polymer or polymer material can be used in each of the first and second, or any additional layer, so long as they are different, provide the desired characteristic(s), and minimize the strains across the disc as a whole.

A preferred method of preparing the disc of the present invention is now described. A solid base or substrate having desired surface details, i.e., a relief pattern capable of being imparted with information such as via a recording material, is placed on a centrifuge having a centrifuge chuck. Optionally, transparent glass or polymer material, including multilayer substrates with prefabricated information layers, nontransparent substrates including metal, glass or polymer, or any combination thereof, can be used as the solid base.

An exemplary procedure to form an optical disc of the invention is as follows. A first polymerizable composition that includes a polymer, for example photopolymer I, is placed on the solid base, and a covering layer of a flexible film material is applied on top. Either the solid base or the flexible material can include the relief pattern and serve as the stamper. A photoinitiator is advantageously added to the first polymerizable composition to facilitate polymerization. Suitable photoinitiators include, for example, heteroorganic or metalloorganic compounds or a mixture thereof, which typically form homogeneous solutions with the polymerizable composition and generate acids, preferably Bronstead acids and/or free radicals under the action of actinic radiation in the range 300-650 nm. The centrifuge chuck is rotated to cause the first polymerizable composition to form a thin, uniform layer through centrifugal force. After the layer is formed and preferably more uniformly distributed to a desired thickness and shape, the polymer material in the layer is cured, for example, by being irradiated with light with a spectral range appropriate for photopolymerization to form a first polymerized layer having a relief pattern.

Once the first polymerized layer hardens, the covering layer is removed, and a second polymerizable composition that includes a polymer, for example photopolymer II, and optionally a photoinitiator, is applied. A covering layer of flexible material is placed on top of the composition opposite the “base” of the first polymerized layer, the composition is centrifuged, and the composition is cured or otherwise solidified sufficiently to form a second polymerized layer having a relief pattern. The relief pattern in the second polymerized layer can then be filled with a recording medium. The resulting multilayer optical disc is subsequently removed from the base, and the relief pattern of the first polymerized layer can then be filled with a recording medium. The recording medium includes any suitable material available to those of ordinary skill in the art, for example, fluorescent material containing an organic or non-organic dye, photochromic material, scattering material like a white paint, and reflective material like a metal paint, or any combination thereof. This procedure may be repeated as many times as desired to obtain a multilayer optical disc with the desired number of layers.

If bi-layer separating layer arrangements are desired between other pairs of information layers in addition to those between the first and second information layers, it may be necessary to next apply a third spacing layer of polymer material that does not contain an information layer, i.e., a recording medium or even a relief pattern, adjacent the existing second information layer. The next layer can either be an information layer/pair of spacing layers/information layer structure as in FIG. 2, or can be a fourth spacing layer adjacent the third spacing layer. In this latter embodiment, a surface of the fourth spacing layer opposite the third spacing layer can contact the third information layer. This permits a pair of spacing layers between every pair of information layers. Other arrangements can be readily envisioned, so long as at least one pair of spacing layers is disposed between at least one pair of information layers.

Returning to the process, after the first polymerizable composition is polymerized, alternatively the solid base and the polymerized layer may be separated. The relief pattern is then filled with a recording medium. The resulting substrate with an information layer is then used as the solid base and placed on a centrifuge. A second polymerizable composition is applied on the side of the base opposite the relief pattern, centrifuged, and polymerized to form a second polymerized layer having a relief pattern. This relief pattern is then also filled with a recording medium.

It is also possible for the first and second polymerized layers, or any additional separating layers, to be prepared separately, i.e., independently, and two or more of the layers then combined, for example, by adhesive. In one embodiment, a dosed amount of adhesive composition is applied to one layer, covered with the second layer, and the two layers with the adhesive centrifuged. The adhesive may then optionally be photosolidified. In another embodiment, adhesive composition is disposed on a surface of each of two separating layers opposite any information layer, and the surfaces then joined and the adhesive cured, so as to form a separating layer arrangement according to the invention.

To avoid any change in the form and/or thickness of the separating layers during processing, each layer including polymer material should preferably be immediately cured upon coating it onto the solid base, through the use of, for example, high temperature (when a polymer solution is applied), or UV radiation (when a liquid photopolymer composition is applied). The curing may be partial or complete, but should be at least sufficient to reduce the tackiness or stickiness, as well as being cured sufficiently to inhibit or prevent undesired further shape modification of the layer.

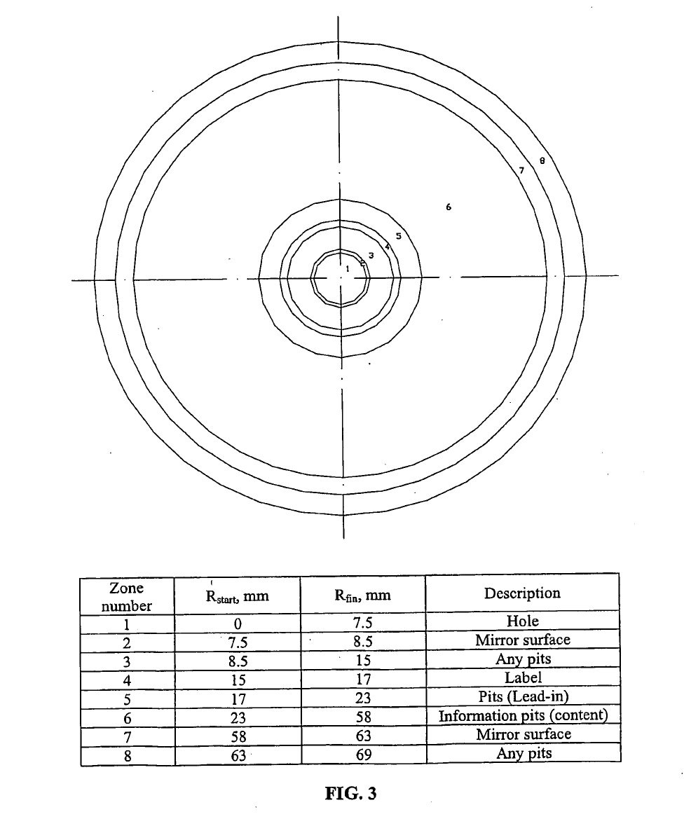

To obtain a better separation between the polymerized layer and the solid base, UV polymerization is preferably performed using a metal mask to limit or prevent UV radiation from irradiating the part of the polymer on the solid base that is located radially farther from the center than the outermost portion of the informational area, Referring to FIG. 3, the metal mask (e.g., aluminum, steel, etc.) can cover areas 7 and 8 to inhibit or prevent the outermost portion of polymer material from being polymerized by minimizing or preventing UV light from contacting the polymer material that has been deposited. As a result, the portion of the polymer material covered by the mask will preferably not be polymerized and can subsequently be removed easily (e.g., by being washed off with a solvent). Without the use of the mask, the polymer material tends to become fully polymerized and can be very difficult to remove from the base.

For increased uniformity of the coating and moistening of polymerizable material, and to minimize or avoid edge effects in applying a coating of the polymer to the surface of the solid base during processing, special lanes or paths, including pits or grooves, can be made in the mirror sections 7 adjacent to the informational area 6, to help prevent the layer of the polymer from being deformed in the event that the mirror surfaces fail to become moistened. A stamper organization is exemplified in FIG. 3. On a common DVD stamper, information pits are only on area 6. The rest of the stamper surface has a mirror surface. The mirrored surface of typical nickel stampers, however, is barely wetted by the photopolymerizable composition during formation of the pits. It can be advantageous to make pits, grooves or any other relief, such as projections, to enhance roughness in other areas 3, 8. Enhanced roughness of the stamper increases the wettability of the stamper so the polymer better contacts it. Area 7 should have a mirror surface to allow for better separation of the disk edge from the stamper.

The term “about,” as used herein, should generally be understood to refer to both numbers in a range of numerals. Moreover, all numerical ranges herein should be understood to include each whole integer within the range.

Although preferred embodiments of the invention have been described in the foregoing description, it will be understood that the invention is not limited to the specific embodiments disclosed herein but is capable of numerous modifications by one of ordinary skill in the art. It will be understood that the materials and procedures used, and the chemical details relating thereto, may be slightly different or modified from the descriptions herein without departing from the methods and compositions disclosed and taught by the present invention.

What is claimed is:

1. A multilayer optical disc comprising:
a plurality of information layers; and
a separating layer arrangement comprising at least two adjacent separating layers, where the separating layer arrangement is located between two information layers and has a thickness sufficient to maintain the at least two information layers spaced apart from each other to minimize strain in the disc,
wherein first and second separating layers of the separating layer arrangement are of different polymer materials to impart different properties to the disc.

2. The disc of claim 1, wherein the separating layer arrangement has 2 to 6 separating layers.

3. The disc of claim 1, having 2 to 10 information layers, each of which is separated by a separating layer arrangement.

4. The disc of claim 1, wherein the properties imparted to the disc comprise one or more of solvent resistance, electrical conductivity, thermal conductivity, refraction value, or a mechanical property.

5. The disc of claim 1, wherein the polymer material comprises one or more photopolymers.

6. The disc of claim 5, wherein the photopolymers comprise bis(4-glycidyloxyphenyl)methane; 1,2,7,8-diepoxyoctane; bisphenol A diglycidyl ether; 1,4-cyclohexanedimethanol diglycidyl ether; 1,4-butanediol diglycidyl ether; bis(3,4-epoxycyclohexylmethyl) adipate; diglycidyl-1,2-cyclohexanedicarboxylate; 3-[bis(glycidyloxymethyl)methoxy]-1,2-propanediol; poly(bisphenol a-coepichlorohydrin), glycidyl end-capped; 3,4-epoxycyclohexylmethyl-3,4-epoxycyclohexane-carboxylate; 3-diglycidyl-1,2-cyclohexanedicarboxylate; poly[(o-cresyl glycidyl ether)-co-formaldehyde]; glycerol proxylate triglycidyl ether; poly(vinylbutyral-co-vinylalcohol-co-vinyl acetate; poly(caprolactone) triol; glycidyl methacrylate; 4-vinyl-1-cyclohexane diepoxide; poly(propylene glycol) diglycidyl ether; glycidyl methacrylate; ethylene glycol divinyl ether; di(ethylene glycol)divinyl ether; trimethylpropane trivinyl ether; 1,6-hexanediol diacrylate; ethoxylated bisphenol A diacrylate; epoxy novolac acrylate oligomer in HDDA; polyester acrylate; styrene; modified urethane triacrylate; 2-(2-ethoxyethoxy)ethyl-acrylate; monopropyleneglycol acrylate; oligocarbonate methacrylate; aliphatic urethane (di)triacrylate; aromatic urethane (di) triacrylate; pentaerythritol triacrylate; tripropylene glycol triacrylate; 4-vinyl-1-cyclohexane 1,2-epoxide; tripropyleneglycol divinyl ester; trimethylpropane triacrylate; diepoxide propyleneglycol; bisphenol A epoxy acrylate; propoxylated neopentyl glycol diacrylate; neopentyl glycol diacrylate; neopentyl glycol ethoxylate diacrylate; hexanediol diacrylate (HDDA); hydroxyethyl(meth)acrylate; tripropyleneglycole diacrylate; epoxy (meth)acrylates; aliphatic urethane (di)triacrylate; aromatic urethane (di)triacrylate; polypropyleneglycol diacrylate (900); 2-phenoxyethyl acrylate; isobornyl acrylate, tris (2-hydroxy ethyl)isocianurate triacrylate, or a mixture thereof.

7. The disc of claim 5, wherein a first polymer material comprises propoxylated trimethylopropane triacrylate; oligocarbonate methacrylate, hexanediol diacrylate (HDDA); polyester acrylate; styrene; tripropylene glycol triacrylate; trimethylpropane triacrylate; neopentylglycol diacrylate, or a mixture thereof, and a second polymer material comprises ethoxylated bisphenol A diacrylate; aliphatic urethane (di)triacrylate; aromatic urethane (di)triacrylate; propoxylated trimethylopropane triacrylate; polypropyleneglycol diacrylate (900); epoxy (meth)acrylates; 2-phenoxyethyl acrylate; isobornyl acrylate; tris (2-hydroxy ethyl)isocianurate triacrylate, or a mixture thereof.

8. The disc of claim 1, wherein each of the separating layers has a thickness of about 15-65 μm.

9. The disc of claim 1, wherein the information layer comprises a plurality of depressions at a surface of each of the at least two separating layers of the separating layer arrangement.

10. A method of making the disc of claim 1, which comprises:
separately preparing each of the different first and second separating layers;
combining the two layers to form a separating layer arrangement; and locating the separating layer arrangement between two information layers.

11. The method of claim 10, wherein combining the two layers comprises disposing a light-reactive adhesive composition between the first and second layers, and photosolidifying the adhesive composition thereto.

12. A method of preparing an optical information storage medium, which comprises:
providing a plurality of pits to a first surface of a first separating layer and to a first surface of a second separating layer, wherein the pits correspond to reproducibly detectable information; and
combining the first and second separating layers by joining a second surface of each separating layer that is disposed opposite the first surface of each separating layer to form a structure having the pits on at least two outer surfaces thereof.

13. The method of claim 12, wherein the second surface of the first and second separating layers is permanently joined by an adhesive composition disposed therebetween.

14. A method of preparing an optical information storage medium, which comprises:
disposing a first polymerizable composition between a base and a covering layer, with at least one of the base and the covering layer having a first relief pattern on a side facing the first polymerizable composition;
rotating the base, the first polymerizable composition, and the covering layer to more uniformly distribute the first polymerizable composition therebetween;
polymerizing the first polymerizable composition while the first polymerizable composition is distributed between the base and the covering layer so as to form a first polymerized layer having a second relief pattern corresponding to the first relief pattern;
filling the second relief pattern with a recording medium;
disposing a second, different polymerizable composition between a side of the first polymerized layer opposite the second relief pattern and a covering layer having a third relief pattern facing the second polymerizable composition;
spinning the base, first polymerized layer, the second polymerizable composition, and the covering layer to more uniformly distribute the second polymerizable composition therebetween;
polymerizing the second polymerizable composition to form a second polymerized layer having a fourth relief pattern corresponding to the third relief pattern; and
filling the fourth relief pattern with a recording medium.

15. The method of claim 14, which further comprises adding one or more photoinitiators to the first or second polymerizable composition before polymerizing the composition.

16. The method of claim 15, wherein the photoinitiators comprise-hydroxy-2-methyl-1-phenyl-1-propanone; benzoin isobutyl ether; bis(η5-2,4-cyclopentadien-1-yl)-bis(2-6-difluoro-3-(1H-pyr-rol-1-yl)-phenyl)titanium; 2,2-dimethoxy-2-phenyl acetophenone; phenanthrenequinone; triethanolamine; camphorquinone; eosin B; dibutylaniline; a 25:75 mixture, by weight, of bis(2,6-dimethoxybenzoyl)-2,4,4-trimethylpentyl phosphine oxide and 2-hydroxy-2-methyl-1-phenylpropan-1-one; a mixture of 1-hydroxycyclohexyl phenyl ketone and benzophenone; mixed triarylsulfonium hexafluoroantimonate salts; triarylsulfonium hexafluoroantimonate; triarylsulfonium hexafluorophosphate; acyl phospho oxides; (η⁵-2,4-cyclopentadien-1-yl)[(1,2,3,4,5,6-η)-(1-methyl ethyl)benzene]-iron (+)-hexafluorophosphate (−1), or a mixture thereof.

17. The method of claim 14, wherein the recording medium comprises one or more of a fluorescent material, photochromic material, scattering material, reflective material, or a combination thereof.

18. The method of claim 14, wherein the first polymerized layer is separated from the base before filling the second relief pattern with the recording medium.

19. The method of claim 14, which comprises filling the fourth relief pattern with the recording medium before filling the second relief pattern.

20. The method of claim 14, wherein the first or second polymerizable composition is photopolymerizable, and the covering layers are at least substantially transparent.

21. The method of claim 14, which further comprises applying a metal mask to a portion of the base during polymerization to avoid polymerizing the polymerizable composition covering such portion.

22. The method of claim 14, further comprising washing the first or second polymerized composition, or both, with a solvent to remove an unpolymerized portion thereof.

23. The method of claim 14, wherein the first relief pattern includes a plurality of projections to increase wettability of the relief pattern to the first polymerizable composition so that the projections form a corresponding pattern thereon.
